(19) United States
(12) Patent Application Publication
(10) Pub. No.: US 2012/0287963 A1
(43) Pub. Date: Nov. 15, 2012

(54) NON-CONTACT TEMPERATURE MEASUREMENT ETALON

(76) Inventors: Yaosheng Chen, Blacksburg, VA (US); Qiao Chen, Blacksburg, VA (US)

(21) Appl. No.: 13/506,689

(22) Filed: Aug. 21, 2010

(51) Int. Cl. G01K 1/00

(52) U.S. Cl. 374/120; 374/E01.001

(57) ABSTRACT

The present invention is a non-contact temperature measurement etalon, the paper discusses a limited area of the “point” of temperature produce light frequency conversion to electricity in frequency, found that any temperature all can be converted to a variety of different electric frequency, but a kind of electric frequency can represent a temperature of irreversible relationship. Due to the accuracy of the temperature with standard than the ordinary highlighted. it high precision 1˜2 orders of magnitude, the temperature of the electricity produced as long as the frequency take upper limit, namely frequency number increased 1˜2 orders of magnitude, it reached the requirements of the temperature etalon.

### FIELD OF INVENTION

The present invention belongs to areas of modern optical technology, fiber optics sensor technology and photo-electronics technology. It illustrates a non-contact temperature measurement etalon, which can be used for high precision temperature sensing and calibrating or demarcating the traditional temperature sensors.

### BACKGROUND OF THE INVENTION

The present invention introduces a temperature measurement etalon, which is a gauge tool for the temperature measurement. The measurement tools for temperature measurement are generally called temperature sensors. As we know, precision of gauge tool is preferred to be at least 1-2 orders of magnitude higher than the measurement tools. Platinum resistors (minus 200 to 900° C.) and Pt—Rh (platinum-rhodium) thermocouples (300□1450° C.) are used as contact temperature measurement etalon, for the reasons of their point temperature measurement, irrelevant to the contact material, and higher measurement precision under the circumstance that the temperature change is limited or slow. There is still no non-contact temperature measurement etalon by now, because most non-contact temperature sensors such as infrared thermometer can not measure a point temperature, be relevant to the material of the surface to be measured, and also be relevant to the measurement distance. Other non-contact temperature sensors such as pyrophotometer, unlike infrared thermometer, measuring temperature with luminance, are with low precision and can not be used as temperature measurement etalon. The theory of infrared thermometer is based on Planck law, i.e. black body radiation law. The reason for Planck conducting his experiment was to revise Wien's displacement law, i.e. the wavelength of the peak of the emission of a black body and its temperature when expressed as a function of wavelength. But the significant contribution for the experiment was to offer an evidence for quantum optics. There were no photodiode and infrared detector at the time Planck doing his experiment. He used a hollow sphere as black body, putting a thermocouple with detecting end at the center for non-contact measuring black body's radiation wave. The radiation wave would heat the thermocouple to get an electromotive force because of thermoelectricity effect. That is the photoelectricity transform process described in Planck's law. But it is a thermoelectricity transduction not the photoelectricity transduction indeed. There are several problems when using Planck's law for temperature measuring. Firstly, only the thermocouple used in contact way can get higher temperature measurement precision. Non-contact way like Planck did can only get a relatively low precision. Secondly, the black body Planck used is a hollow sphere, integrating all the temperature energy come from each small area from the sphere surface to the center. That application situation can not be occurred for the actual application of the non-contact temperature sensors.

The present invention indicates that the temperature change in a material surface would induce the change of wave energy and heat energy, both of which can represent the temperature respectively. There are two energies, radiant energy and conductive energy, on each material surface and sum of the two energies is the same if temperature remains the same. Black body is also with the two energies, but with a much higher radiant energy than conductive energy. So when measuring different material in same temperature, thermocouple will get same temperature measurement results by contact measurement, but non-contact measurement may get different output, especially when the materials to be measured are among good conductors such as gold, silver, copper and aluminum etc. The radiation intensity described in Planck's law is verified related to the material, surface color and roughness. Generally, the radiant coefficient is during the range of 0.04-1.0 according to material, surface color and roughness, radiant coefficient of black body can be defined as 1.0. The uncertain radiant coefficient may induce confused temperature measurement results. The present invention use wave energy to measure the temperature. Because heat energy and wave energy are two different physical quantity, wave energy can be used for temperature measurement in high speed measurement, for the reason that transmitting speed of wave energy is 300 thousands kilometers per second. A high speed response photoelectricity detector can obtain wave energy by non-contact measurement. The process is same to contact heat energy measurement only with different sensor. The present invention also validates that for the influences of convection, conduction and radiation, temperature distribution in a material surface is asymmetry. Even for a vacuum flask, there is still temperature grade on its surface.

Only the point temperature can represent an accurate temperature measurement. The present invention shows a way for getting point temperature by non-contact measurement. By using the lens imaging and phase transformation function, emanative spherical wave radiated from each point on the object plane may be transformed to the focal spherical wave. Due to the Fourier transform function, wave energy from each point on the object plane can be transferred to the rear focal plane of the lens, i.e. the image plane. Wave energy from wave source is usually larger than the radiation wave's wave energy. Like a camera taking a photo, if the photo is focused with no distortion, that means wave energy of the object surface (wave source) will reach image plane; if it is with distortion, that means there are some radiation waves reach the image plane. Although the radiation wave is a part of the wave energy of wave source, its waveform is unlike the waveform of wave source. If there is no distortion, waveform of the image plane is the same as that of the wave source. Optical fiber can be used for coupling and transmitting the image. By precisely adjusting the distance, the input end of optical fiber can achieve good image coupling. The output of the optical fiber is the optical analog data, which can be converted to the optical digital data and transmitted for a long distance. It also can be converted to the electrical digital data. Such digital data represents corresponding wave number which is proportional to temperature. The digital data can be processed by a microprocessor system and the temperature value can be obtained and displayed. The temperature measurement etalon is realized as the non-contact optical point temperature measurement, irrelevant to the material, radiant wave, heater surface area and measurement distance. Such etalon can be regarded as a temperature gauge tool, which precision is at least 1-2 orders of magnitude higher than that of the temperature sensors to be calibrated.

### BRIEF DESCRIPTION OF THE DRAWINGS

FIG. 1 shows structure sketch map of a non-contact temperature measurement etalon.

Optical spectrum information of the goal surface transmits to the objective lens 1, and be separated into two routes by the demultiplexer 2. One of the two routes is focused to the index plate 3 and can be read by the ocular lens 4. Another route will focus wave energy from each point of object plane to the focal plane of the objective lens. The GRIN lens 6, optical spectrometer □ and the large core optical fiber 8 will realize the characteristics of the point temperature measurement and irrelevance to the radiant coefficient. The functions of photodetector 10, logarithm amplifier 11, operation amplifier 12 and optical switch 13 are to convert the optical analog data to the optical digital data. The functions of infrared 100 MBPS LED 14, photodiode 15, pulse shaping amplifier 16, optical fiber 22 and photodiode comparing circuit 24 can avoid interference between analog data and digital data. Microprocessor 17 will take count of digital signals and connect to computer 18 for displaying temperature value. All the components are fixed in a mechanical fixture. To conveniently aim at the goal to be measured, there are one LCD screen and 4 pushbuttons on the fixture. The function extension chip 19 is used to extend and update the functions. Control signal can be either the analog data from the function extension chip 19 or the digital data from the computer 18.

REFERENCE NUMERALS IN DRAWING

| | |
|---|---|
| 1. | Object lens |
| 2. | Demultiplexer |
| 3. | Index plate |
| 4. | Ocular lens |
| 5. | Reflector mirror |
| 6. | GRIN lens |
| 7. | Optical spectrometer |
| 8. | Large core optical fiber |
| 9. | Adjusting mechanism |
| 10. | Photodetector |
| 11. | Logarithm amplifier |
| 12. | Operation amplifier |
| 13. | Optical switch |
| 14. | Infrared 100 MBPS LED |
| 15. | Photodiode |
| 16. | Pulse shaping amplifier |
| 17. | MCU |
| 18. | Computer |
| 19. | Function extension chip |
| 20. | LCD screen |
| 21. | 4 pushbuttons |
| 22. | Optical fiber |
| 23. | 24VDC electrical source |
| 24. | Photodiode comparing circuit |

FIG. 2 shows how the point image telescope can get an in-focus image. If the image plane is in focus and without distortion, wave energy of each point on the object plane will totally reach image plane before being separated to two parts. Because the light wave transmitting speed is 300 thousands kilometers per second, in a limit non-contact measurement distance, the time for the wave energy transmitting is far less than the time of wave energy from generating to separating, that will conquer the limit that the traditional non-contact temperature measurement can only measure the radiant wave. So the present invention is irrelevant to the heater surface area, material radiance and measurement distance.

FIG. 2A is a schematic diagram of manual focusing.

FIG. 2B is a schematic diagram of automatic focusing. No. 25 is an optical adaptive focusing device, an optical faceplate composed by hundreds of fiber glasses with diameter less than 50 μm, bundled together with thickness in the range of 2-4 mm.

FIG. 2C is a schematic diagram of non-focusing.

FIG. 2D shows how to focus by adjusting the couple distance between optical fiber end and optical spectrometer.

FIG. 3 gives an example of the application of present invention, a temperature calibration device. The traditional calibration devices, such as black body furnace, are always with high energy consumption, time-consuming and also expensive. Although the idea that using an incandescent lamp to replace such calibration furnace had been put forward for several years, it is not realized for some technical reasons. The present invention can be applied for a novel, high speed middle and high temperature calibration furnace with low price.

REFERENCE NUMBERS IN DRAWING

| | |
|---|---|
| 31. | Etalon in the present invention |
| 32. 37. | Two same collimator |
| 33., 36. | Two same wave splitter |
| 34. | Fan |
| 35. | Incandescent lamp |
| 38. | Temperature sensor to be calibrated |
| 39. | Computer |
| 40. | Regulated voltage or current power supply |

### DETAILED DESCRIPTION

The present invention is a non-contact temperature measurement etalon used for calibrating temperature sensor. As a gauge tool for temperature measurement, there are two characteristics must have. (1) It can obtain a small zone (point) temperature; (2) The measurement results must be irrelative to the radiance of surface material to be measured. The etalon has a higher precision and it is at least 1-2 orders of magnitude higher than that of the temperature sensors to be calibrated. If precision of the temperature sensor to be calibrated is 1° C., then the precision for the temperature measurement etalon must be at least 0.1° C.

To reach the above claim, the present invention uses a lens with visual angle less than 20 degree, which adds a GRIN lens (a micro plane lens) can be a point image telescope. The wave energy on object plane will pass through the point image telescope before it separating to radiation wave and conductive wave. The wave energy of heat source surface will image to the rear end of the GRIN lens with no distortion. The optical spectrometer then chose only the max-value wave energy of each point on the object plane entering into optical spectrometer and other wave energy can not enter. Sensor optical fiber will couple the max-value wave energy on the image plane to reduce the measured area, that can be regarded as point temperature measurement. The waveforms of the output of sensor optical fiber are similar to the wave energy waveform of the heat source surface. The wavelength variety will be measured by the optical spectrometer. Because the wavelength is a reciprocal of the wave number, the output analog data can be converted to the optical digital data by the differential means, such process fit the rule that peak wavelength became shorter and wave number became larger with the temperatures increase. The wave number can be converted to the fringe number by a crystal oscillator. Microprocessor will take count of bits to obtain corresponding temperature value. The types of crystal oscillator will determine the precision of the etalon. For example, a temperature change of 0.1° C. may correspond to 10 bits or 100 bits and even more. Higher fringe number means higher precision. To keep image plane in focus, some methods such as manual focusing, auto focusing and even non-focusing are adopted. Non-focusing means that a two dimensional diffraction screen is put on the former focus of objective lens so that the image plane remains focused. To solve the issue that resolution of the image plane may decrease with the increase of the measurement distance, another optical fiber with large core can be used for coupling other relative max-value wave energy from the optical spectrometer as a reference. By comparing the reference signal and the max-value wave energy, the measurement results could be irrelevant to the measurement distance.

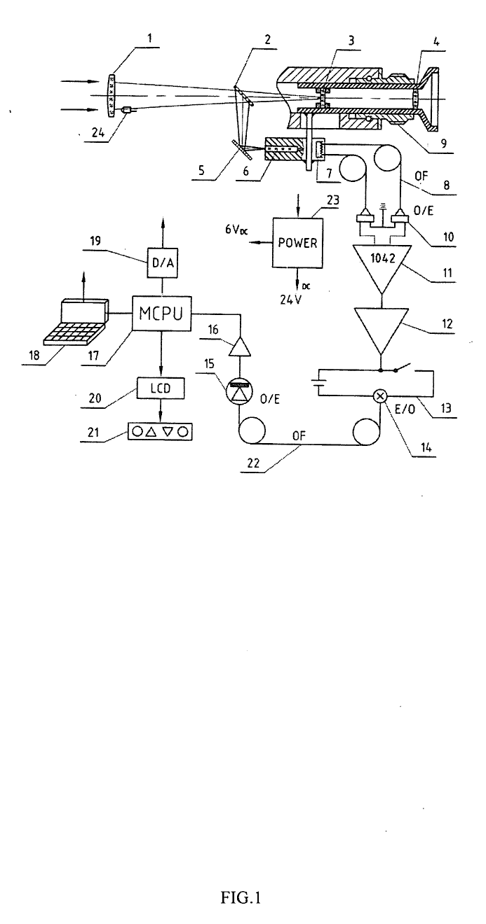

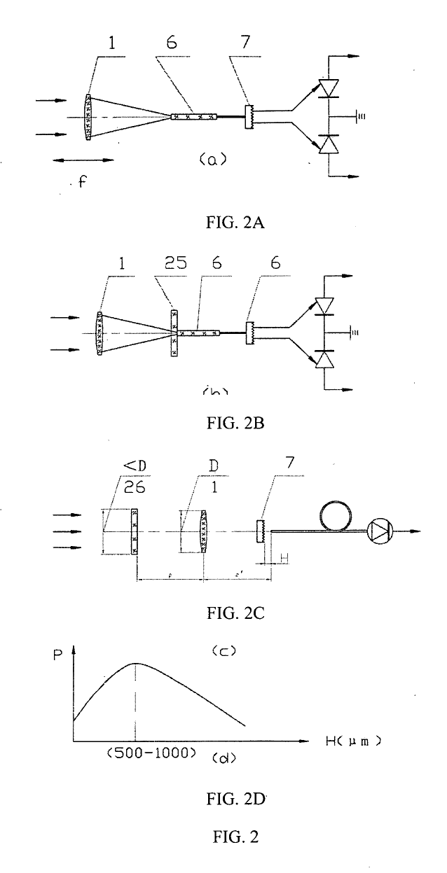

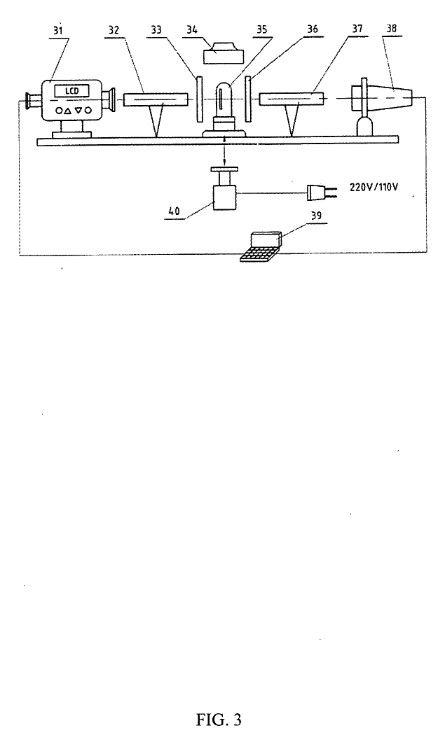

FIG. 1 shows one non-contact temperature measurement etalon of the present invention. The wave energy of the target surface to be measured (name as object plane or wave source) will pass through the sphere lens 1 to the demultiplexer 2. 30% of the light can transmit the demultiplexer and focus on the index plate 3. The ocular lens 4 is used for target aiming, which makes the object plane image at index plate in-focus. The infrared line represents wave energy of the heater, reflected by the demultiplexer 2 and the reflector mirror 5, and focused on the GRIN lens 6 front end. Here, index plate 3 and GRIN lens 6 are composed as a linkage structure. By adjusting the ocular lens 4, in-focus image plane can be obtained, and the image plane on the rear end of the GRIN lens is also in focus. The optical spectrometer 7 detects the max-value wave energy and other relative max-value wave energy of the wave source from the image plane, which are coupled into two optical fibers 8, respectively. The two temperature signals will be converted to the electrical current signals by the photodetector 10. The two signals will be divided by logarithm amplifier and get a signal irrelevant to the measurement distance. The signal then input to the operation amplifier 12 to get a suitable signal to fit optical switch 13, which output is proportional to the input analog data. Then the optical analog data output from optical spectrometer are converted to the optical digital data, where the digital data is bit indeed. So, optical switch can be regarded as an adaptive bit transformer, which bit number is inversely proportional to the wavelength but proportional to the wave number. The optical digital data is filtered by the optical fiber 22 and converted to the electrical digital data by the photodiode 15. The electrical digital data will be amplified by the amplifier 16 and input to the micro-controller unit (MCU) 17 (microprocessor). The computer 18 will record and display the temperature information and output control signal to some devices such as heat furnace. Some function extension chips 19 can convert the digital data into the analog data (D/A) such as 0-20 mA or 4-20 mA current signals or 0-5V voltage signal. An RS485 interface can be connected to the MCU directly, which may be with functions of setting temperature, displaying and controlling temperature. A PID system can also be connected to the function extension chip 19. Because secondary instrument (computer or cabinet) may be far from etalon, for convenient maintenance, LCD screen 20 is fixed on the etalon box. Button 21 is used to adjust parameters. Electrical source 23, ±12V_{DC} or 24V_{DC}, is always on etalon box or cabinet. When the temperature to be measured is less than 400° C., influence of the sunlight and incandescence light is severe. To solve the issue, photodiode 24 and operation amplifier 12 are used, which can be placed at front or behind the objective lens 1. At the beginning of measurement, the temperature is low and the original output of operation amplifier 12 is set to zero to compensate white light interference. With the temperature increase, the white light interference may decrease.

FIG. 2 shows how to realize the non-contact temperature measurement irrelevant to the material radiance. Because the transmitting speed of wave energy in atmosphere and optical fiber is very high, the wave energy from the wave source can be imaged to the telescope image plane. Because the temperature change of object plane may induce the change of heat energy or wave energy, which may induce the temperature distribution in the object surface being uneven, only the point temperature can be regarded as true temperature value. The target surface to be measured is imaged to the GRIN lens rear end with no distortion, and the image is coupled to an optical fiber with same optical axes of GRIN lens. Because the diameter of the optical fiber is less than 300 μm, non-contact point temperature measurement is realized. The rear focal plane of objective lens is regarded as the image plane. An aperture diaphragm with aperture diameter of 1-18 mm is put on the front focal plane of objective lens. The diameter of aperture diaphragm is decided by the non-contact measurement distance. Two dimensional diffraction gratings are fixed between the lens and its rear focus. In this way, there is no need of focusing as the measurement distance changes. Shown as FIG. 2(c), the present invention can not only relate to a point temperature sensor, but also a waveform viewer. In the present invention, the spherical lens 1 and the GRIN lens 6 are composed to a telescope. When the image plane is on the rear end of GRIN lens with diameter of φ2-φ6, it is a collimating light. The optical spectrometer chooses the max-value temperature wave energy and other relative max temperature wave energy, coupled by two optical fiber 8, respectively. The coupling efficiency calculation is shown in FIG. 2(d). When the optical fiber input end is directly connected to the optical spectrometer (i.e. H=0), the area to be measured is the smallest and the output value is the lowest. As H increasing, the area becomes larger and the output value increases. When H is increased to 0.5-1 mm, the output value may drop gradually. An optical power meter can be used to adjust the interval H. The diameter of spherical lens in present invention is 25.4 mm, i.e. 1 inch, focal length of 60 mm. The GRIN lens used is a quarter period lithium glass stick, diameter of φ2 mm, length of 14 mm. All the parameters can be changed according to practice applications, including optical fiber diameter, 300 μm. The optical spectrometer is a transmission grating, which can separate diffraction light and interference light. The 0 order fringe is an interference stripe and 1, 2 order are diffraction stripes. As we know, two lights interference must need three conditions: 1, same frequency; 2, same vibration direction; 3, fixed phase difference. It is known from condition (1) that lights on the object plane with same frequency means they are with same temperature and same wavelength. Condition (2) and (3) mean that the light intensity output from the optical spectrometer is proportional to the light intensity of object plane and with same waveform. So the measurement results are irrelevant to the material radiance. The size of optical point is smaller than the receiving lens aperture. If temperature distribution in the point is uneven, by spectrum filtering in the optical spectrometer, only the highest temperature signal can be transmitted though the optical spectrometer and focused to image plane. FIG. 2(a) is an illustration of manual focusing, similar to moving objective lens in a camera, to make the image plane in focus seen from ocular lens. FIG. 2(b) shows how to realize auto focusing. An optical adaptive focusing system is located on the objective lens focal plane, and is directly cling to the GRIN lens. The adaptive focusing system is made of several hundreds of optical fibers or optical fiberglass with thin envelope and diameter less than 50 μm. The fibers are bundle together for melting to one part and be chopped to slices with diameter less than 10 mm, thickness of 2-4 mm, polishing with both sides. The adaptive focusing system can be used for auto focusing. FIG. 2(c) shows a non-focusing optical system. If the image is in focus, the light waveform output from optical spectrometer will be similar to the waveform of wave source. By using optical fibers to couple wave energy output from optical spectrometer, and comparing the max-value temperature wave energy and other max-value temperature wave energy, the issue that the precision may decrease with non-contact measurement distance increase can be solved. Practically, the non-contact measurement distance is limited by the detecting ability of components.

The present invention shows a non-contact temperature measurement etalon. A novel signal processing method, with no linear calibration is used to make the measurement with high precision and adjustable precision. As we know, an analog data can be divided into several micro units by differential process. If these micro units enter a ‘gate’ one by one, they can form a line of output which is same to convert the analog data level to the digital data level the in a signal processing circuit. The key is how to find the rule for forming the line. It can be seen from FIG. 1 that optical analog data can be converted to the electrical analog data by a photodetector 10. The logarithm amplifier 11 will change the electrical analog data to a line in logarithm coordinates. When the analog data is converted to bits, the output is a line. If the bits are divided equally, it is same to divide the line equally, i.e. dividing corresponding temperature equally. The present invention can insure the bits to form a line by using logarithm division. It means linear calibration is not needed. High frequency crystal oscillator with a work frequency higher than 100M and an optical switch 13 can be used. Although temperature may become higher as bits being larger, the bits in same temperature interval will be less and less as temperature enhance in logarithm coordinates. In processing software, by calculating and using the upper limit of bits corresponding to 1° C., 0.1° C. or 0.01° C. temperature variety, the precision and stability can all be good. (2) The characteristics are often a little different for the components used, which may induce the output characteristic of device systems in difference. The calibration method is used to solve such issue. The output is set as the origin and by rolling bits to form the lines with same slope, each sensor output may be in uniform. There is no linear calibration circuit for signal processor in the present invention.

Black body furnace is not necessary to be used as the calibration furnace of present invention, some light source such as incandescent lamp can be used, as FIG. 3 shown, that may help for shorterning the calibration and production period and energy saving.

### APPLICATION EXAMPLE

A□ It can be used as a novel high temperature calibration device, shown as FIG. 3. Halogen lamp, stage light and tungsten ribbon lamp can be used as wave source, put at the interval, about 60 cm-70 cm, of two collimator. One side is one non-contact temperature measurement etalon of the present invention, and another side is a temperature sensor to be calibrated.
B□ It can also be used as a non-contact point temperature sensor. Commonly, a gauge temperature etalon is always used indoor and the precision must meet certain international codes. But the optical point temperature sensor in the present invention can be used in some harsh environment.

We claim:

1. A non-contact temperature measurement etalon is with three characteristics:
irrelevant to the surface material to be measured, realizing the non-contact point temperature measurement, irrelevant to the non-contact measurement distance. (a) If the image plane is in focus in the ocular lens, the waveform output from point image telescope composed by spherical lens and GRIN lens is similar to the waveform of wave source that insure the measurement results irrelevant to the surface material to be measured. (b) Optical spectrometer can get the max-value wave energy which is coupled by optical fiber. Because the diameter of the optical fiber is less than 300 μm, it can be regarded as the point temperature measurement. (c) Another optical fiber is used to couple optical spectrometer other max-value wave energy, the ratio of other max value wave energy and max value wave energy is used to represent temperature, the influence that wave energy decrease with distance can be avoided.

2. A non-contact temperature measurement etalon as recited in claim 1, three methods to obtain image plane in-focused of the point image telescope are used. Three focusing methods, manual focusing, auto focusing and non-focusing, are shown in FIG. 2a/b/c. The adaptive focusing system can be used for auto focusing. The adaptive focusing system is made of several hundreds of optical fibers or optical fiberglass with thin envelope and diameter less than 50 μm. The fibers are bundled together for melting to one part and be chopped to slices with diameter in range of 5-8 mm, thickness of 2-4 mm, polished with both sides. Its input end is connected to the GRIN lens directly with the same optical axes, and it output collimated light to the optical spectrometer.

3. A non-contact temperature measurement etalon as recited in claim 2, in which the optical spectrometer is a transmission phase grating, which is 150-300 lines per millimeter. The material can be common optical glass, cadmium selenide infrared glass or amorphous silicon according to the temperature range to be measured. By choosing the temperature range to be measured, its zero order stripe is an interference stripe and the first-order stripe is a diffraction stripe. We can use two optical fibers with same core diameter and same length, 150 mm, to couple zero order and the first-order light. By comparing the first-order and zero order light and taking logarithm, the temperature measurement precision can be improved.

4. A non-contact temperature measurement etalon as recited in claim 3, two optical fibers connected to two uniform photodetectors are used. Logarithm amplifier will amplify the ratio of the first order light and zero order light. The second amplifier makes the signal to fit an optical switch. All these can be regarded as an adaptive bits convertor, which can convert the temperature optical analog data to the optical digital data.

5. A non-contact temperature measurement etalon as recited in claim 4, the optical digital data can be transmitted for a long distance by using optical fibers. The optical fiber can also isolate the digital data and the analog data to avoid interference. Photodetector will convert the optical signal to the electrical signal. The bits are sent to micro-controller unit (MCU) to obtain corresponding temperature value. The signal processing method in present invention introduces a way to get adaptive bits (optical switch). Analog data in differential are corresponding to bits which will be a line in logarithm coordinates. By dividing the line, it is noted that with the temperature increases, the bits become larger. To ensure enough bits in 0.01° C., 0.1° C. or 1° C. temperature interval, it will lead to a high and adjustable precision.

6. A non-contact temperature measurement etalon as recited in claim 5, to keep the etalon in uniform during producing period in a large scale, calibration method is used. The bits will from a line in logarithm coordinates. The temperature lowest value is set as coordinate origin. By rolling bits to form the lines with same slope, each sensor output may be in uniform.

7. The basic optical system in present invention is a combination of one lens and one sensor optical fiber. The output waveform from the optical fiber is similar or dissimilar to wave source waveform. To distinguish the wave energy from wave source or radiation wave, several optical components such as optical adaptive focusing system, optical spectrometer and GRIN lens can be put into interval between optical fiber and lens. Consider all the different components combination, 5 different optical systems can be realized.

8. A non-contact temperature measurement etalon as recited in claim 7, if another optical fiber is added to couple other optical max-value signal, there are two optical fiber for coupling other max-value wave energy. The wavelength of output signal from each optical fiber may be different. By comparing the two outputs, the influence of different measurement distances can be reduced. Even more optical fibers can be used for comparing multiple parameters to make a multiple parameters sensors which the parameters may induce by temperature variety.

9. A non-contact temperature measurement etalon as recited in claim 8, if the optical spectrometer is a common transmission grating instead and the output of grating is directly cling to a photodetector array, or infrared CCD, it can be used as a sort of night vision waveform viewer.

10. The temperature etalon of present invention can measure high temperature. The traditional calibration furnace, black body furnace, may not be used for calibration here. Some convenient lights such as a stage light lamp and an incandescent lamp can be used as a temperature calibration furnace.
